(19) United States
(12) Patent Application Publication
(10) Pub. No.: US 2026/0367661 A1
(43) Pub. Date: Nov. 19, 2026

(54) APPARATUS FOR PREVENTING SIMULTANEOUS OPERATING OF ACCELERATOR PEDAL AND BREAK PEDAL

(71) Applicant: GM Global Technology Operations LLC, Detroit, MI (US)

(72) Inventors: Geehoon Sung, Incheon (KR); Juwon Kim, Seoul (KR); Sunggun Kim, Incheon (KR)

(73) Assignee: GM Global Technology Operations LLC, Detroit, MI (US)

(21) Appl. No.: 19/206,817

(22) Filed: May 13, 2025

(51) Int. Cl. G05G 1/36; B60K 26/02; B60T 7/04; G05G 1/44; G05G 5/00

(52) U.S. Cl. CPC G05G 1/36; B60K 26/02; B60T 7/04; G05G 1/44; G05G 5/005; G05G 2505/00

(57) ABSTRACT

A vehicular pedal system includes an accelerator pedal and a brake pedal configured to pivotably mount at a vehicle. The accelerator pedal is configured to pivot between first and second positions to actuate a propulsion system of the vehicle. The brake pedal is configured to pivot between first and second positions to actuate a braking system of the vehicle. A stopper is pivotable relative to the accelerator and brake pedals. Responsive to the brake pedal moving from its first position toward its second position, the stopper is configured to pivot toward engagement with the accelerator pedal to preclude movement of the accelerator pedal toward its second position. Responsive to the accelerator pedal moving from its first position toward its second position, the stopper is configured to engage the accelerator pedal and pivot according to movement of the accelerator pedal to preclude movement of the brake pedal toward its second position.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a vehicular pedal system that prevents or precludes the simultaneous operation of an accelerator pedal of the vehicle and a brake pedal of the vehicle. More particularly, the present disclosure relates to a vehicular pedal system including a mechanical stopper that prevents or precludes movement of one of the acceleration pedal and the brake pedal of the vehicle responsive to movement of the other of the accelerator pedal and the brake pedal.

A driver of a vehicle may attempt to simultaneously operate both an accelerator pedal of the vehicle and a brake pedal of the vehicle, such as due to a state of confusion, panic, or inexperience. However, operating the accelerator pedal and the brake pedal of the vehicle at the same time can place strain on the propulsion system and braking system of the vehicle and may present a hazard to the equipped vehicle and other vehicles on the road.

### SUMMARY

One aspect of the disclosure provides a vehicular pedal system. The system includes an accelerator pedal configured to pivotably mount at a vehicle equipped with the vehicular pedal system. The accelerator pedal is configured to pivot between a first position, where a propulsion system of the vehicle is not actuated, and a second position, where the propulsion system of the vehicle is actuated. The system includes a brake pedal configured to pivotably mount at the vehicle. The brake pedal is configured to pivot between a first position, where a braking system of the vehicle is not actuated, and a second position, where the braking system of the vehicle is actuated. The system includes a stopper pivotable relative to the accelerator pedal and the brake pedal. Responsive to the brake pedal moving from its first position toward its second position, the stopper is configured to pivot toward engagement with the accelerator pedal to preclude movement of the accelerator pedal from its first position toward its second position. Responsive to the accelerator pedal moving from its first position toward its second position, the stopper is configured to engage the accelerator pedal and pivot according to movement of the accelerator pedal to preclude movement of the brake pedal from its first position toward its second position.

Implementations of the disclosure may include one or more of the following optional features. In some implementations, the accelerator pedal and the stopper are configured to pivot about a first pivot axis and the brake pedal is configured to pivot about a second pivot axis different than the first pivot axis.

In some examples, the system further includes a gear train that is operably connected to the accelerator pedal, the brake pedal, and the stopper. In further examples, the gear train includes a first gear pivotable according to movement of the brake pedal and a second gear pivotable relative to the accelerator pedal. The stopper is pivotable according to movement of the second gear. In even further examples, responsive to the brake pedal moving from its first position toward its second position, the first gear pivots in a first direction and causes the second gear to pivot in an opposite second direction to move the stopper toward engagement with the accelerator pedal. In some even further examples, responsive to the accelerator pedal moving from its first position toward its second position, the accelerator pedal engages the stopper and causes the second gear to move in the first direction to move the first gear in the first direction and preclude movement of the brake pedal. In other even further examples, the gear train includes a third gear disposed between the first gear and the second gear. Optionally, a linkage extends between the third gear and the second gear to pivotably connect the second gear and the third gear. In some other even further examples, a linkage extends between the first gear and the second gear to pivotably connect the first gear and the second gear.

In some aspects, the system further includes a mounting plate configured to mount at an interior cabin of the vehicle. The accelerator pedal includes a first lever having a first end pivotably mounted at the mounting plate and an opposite second end including a first foot pad configured to receive an accelerator pedal actuation force from a driver of the vehicle that moves the accelerator pedal from its first position toward its second position. The brake pedal includes a second lever having a first end pivotably mounted at the mounting plate and an opposite second end including a second foot pad configured to receive a brake pedal actuation force from the driver of the vehicle that moves the brake pedal from its first position toward its second position.

Another aspect of the disclosure provides a vehicle. The vehicle includes a pedal system including an accelerator pedal pivotably mounted at the vehicle. The accelerator pedal is configured to pivot between a first position, where a propulsion system of the vehicle is not actuated, and a second position, where the propulsion system of the vehicle is actuated. The pedal system includes a brake pedal pivotably mounted at the vehicle. The brake pedal is configured to pivot between a first position, where a braking system of the vehicle is not actuated, and a second position, where the braking system of the vehicle is actuated. The pedal system includes a stopper pivotable relative to the accelerator pedal and the brake pedal. Responsive to the brake pedal moving from its first position toward its second position, the stopper is configured to pivot toward engagement with the accelerator pedal to preclude movement of the accelerator pedal from its first position toward its second position. Responsive to the accelerator pedal moving from its first position toward its second position, the stopper is configured to engage the accelerator pedal and pivot according to movement of the accelerator pedal to preclude movement of the brake pedal from its first position toward its second position. This aspect may include one or more of the following optional features.

In some implementations, the accelerator pedal and the stopper are configured to pivot about a first pivot axis. The brake pedal is configured to pivot about a second pivot axis different than the first pivot axis.

In some aspects, the pedal system further includes a gear train that is operably connected to the accelerator pedal, the brake pedal, and the stopper. In further aspects, the gear train includes a first gear pivotable according to movement of the brake pedal and a second gear pivotable relative to the accelerator pedal. The stopper is pivotable according to movement of the second gear. In even further aspects, responsive to the brake pedal moving from its first position toward its second position, the first gear pivots in a first direction and causes the second gear to pivot in an opposite second direction to move the stopper toward engagement with the accelerator pedal. In some even further aspects, responsive to the accelerator pedal moving from its first position toward its second position, the accelerator pedal engages the stopper and causes the second gear to move in the first direction to move the first gear in the first direction and preclude movement of the brake pedal. In other even further aspects, the gear train includes a third gear disposed between the first gear and the second gear. Optionally, a linkage extends between the third gear and the second gear to pivotably connect the second gear and the third gear. In some other even further aspects, a linkage extends between the first gear and the second gear to pivotably connect the first gear and the second gear.

In some examples, the pedal system further includes a mounting plate configured to mount at an interior cabin of the vehicle. The accelerator pedal includes a first lever having a first end pivotably mounted at the mounting plate and an opposite second end including a first foot pad configured to receive an accelerator pedal actuation force from a driver of the vehicle that moves the accelerator pedal from its first position toward its second position. The brake pedal includes a second lever having a first end pivotably mounted at the mounting plate and an opposite second end including a second foot pad configured to receive a brake pedal actuation force from the driver of the vehicle that moves the brake pedal from its first position toward its second position.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a plan view of a vehicle equipped with a pedal assembly configured to prevent or preclude simultaneous operation of the accelerator pedal and brake pedal.

FIGS. 2A and 2B are partial plan views of the pedal assembly.

FIG. 2C is a schematic view of the accelerator pedal and a first example linkage system of the pedal assembly.

FIG. 2D is a schematic view of the pedal assembly equipped with the linkage system of FIG. 2C.

FIG. 3A is a schematic view of the accelerator pedal and the linkage system of FIG. 2C, with the accelerator pedal and the brake pedal in respective idle positions.

FIG. 3B is a schematic view of the accelerator pedal and the linkage system of FIG. 2C, with the brake pedal moved from its idle position toward its actuated position and with the accelerator pedal in its idle position.

FIG. 3C is a schematic view of the accelerator pedal and the linkage system of FIG. 2C, with the brake pedal in its idle position and with the accelerator pedal moved from its idle position toward its actuated position.

FIG. 4A is a schematic view of the accelerator pedal and a second example linkage system of the pedal assembly, with the accelerator pedal and the brake pedal in respective idle positions.

FIG. 4B is a schematic view of the accelerator pedal and the linkage system of FIG. 4A, with the brake pedal moved from its idle position toward its actuated position and with the accelerator pedal in its idle position.

FIG. 4C is a schematic view of the accelerator pedal and the linkage system of FIG. 4A, with the brake pedal in its idle position and with the accelerator pedal moved from its idle position toward its actuated position.

FIG. 5A is a schematic view of the accelerator pedal and a third example linkage system of the pedal assembly, with the accelerator pedal and the brake pedal in respective idle positions.

FIG. 5B is a schematic view of the accelerator pedal and the linkage system of FIG. 5A, with the brake pedal moved from its idle position toward its actuated position and with the accelerator pedal in its idle position.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

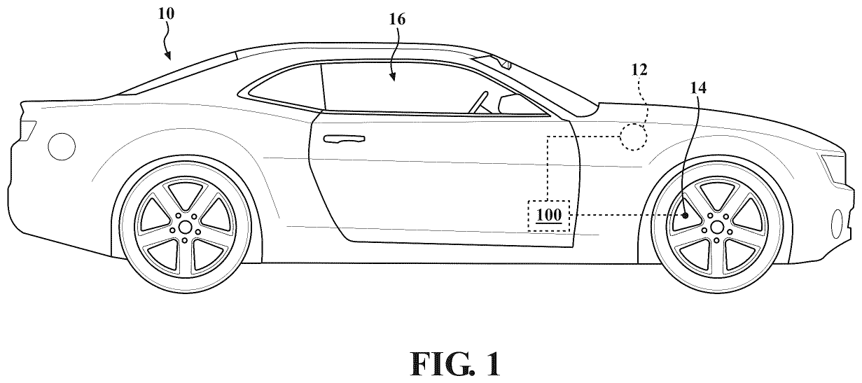

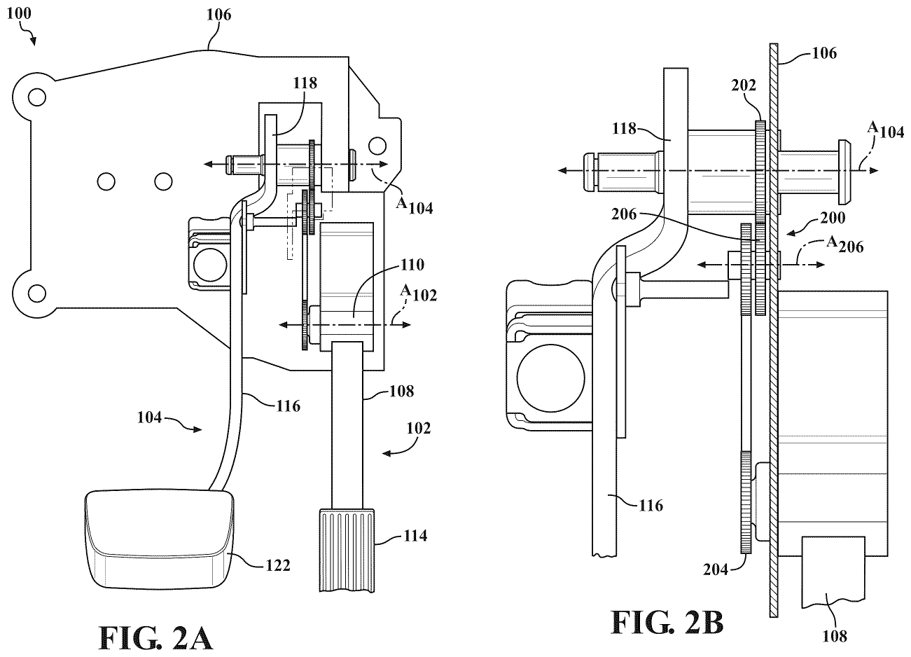

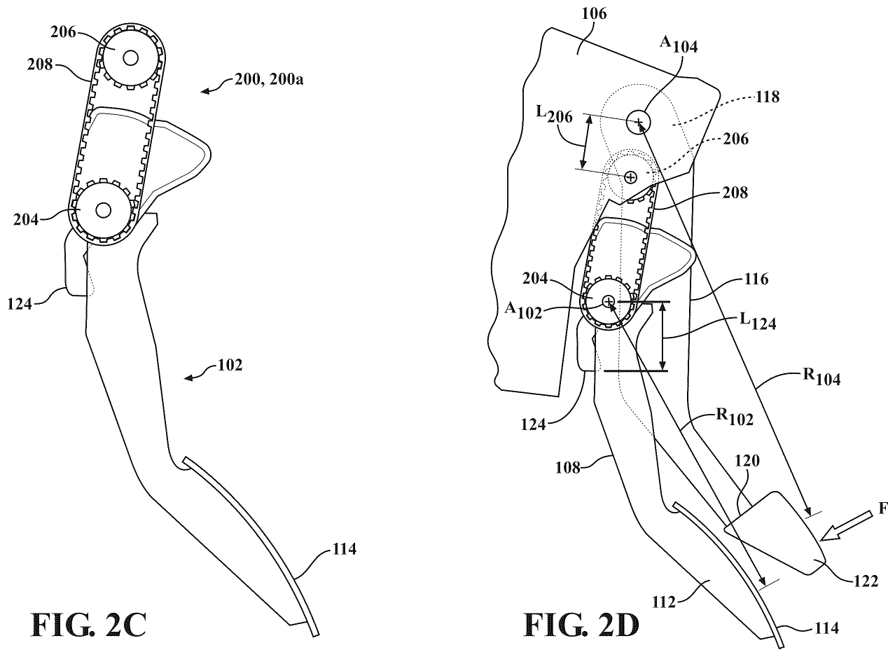

Referring now to the figures and the illustrated configurations depicted therein, a vehicle 10 includes a propulsion system 12 configured to drive or move the vehicle 10 and a braking system 14 configured to slow the vehicle 10 and bring the vehicle 10 to a stop (FIG. 1). Moreover, the vehicle 10 includes a pedal system or assembly 100 that is disposed at an interior cabin 16 of the vehicle 10, such as beneath a dashboard and steering column of the vehicle, and that includes an accelerator pedal 102 and a brake pedal 104 (FIGS. 2A-2D). A driver of the vehicle 10 interacts with or operates the accelerator pedal 102 and the brake pedal 104 to respectively control operation of the propulsion system 12 and the braking system 14.

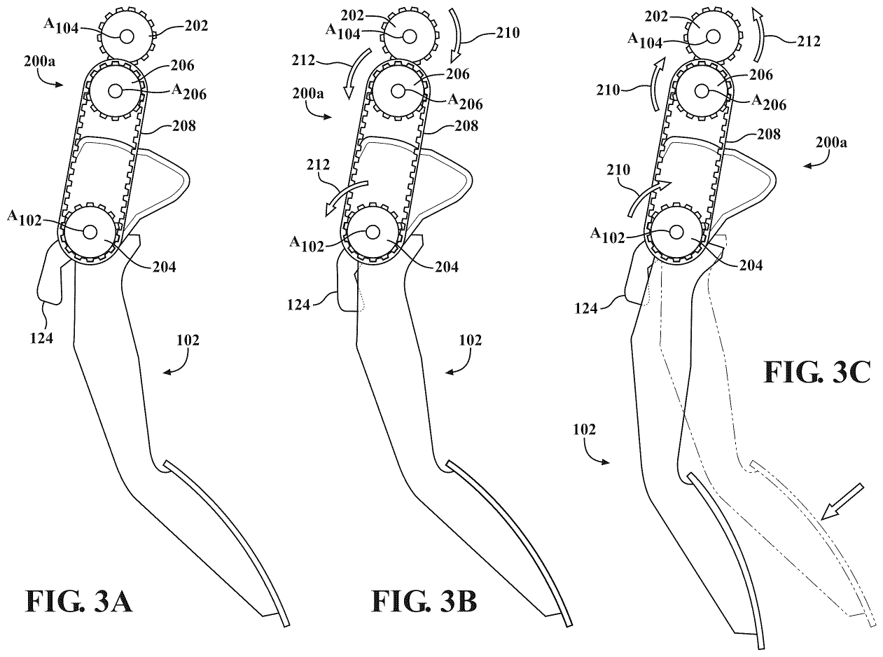

In the illustrated example, the pedal system 100 further includes a mounting plate or panel 106 configured to mount the pedal system 100 at the interior cabin 16 of the vehicle 10. The mounting plate 106 may attach at or beneath the dashboard of the vehicle 10 to secure the pedal system 100 at the vehicle 10. The accelerator pedal 102 includes an arm or lever 108 having a first end portion 110 pivotally mounted at the mounting plate 106 and a second end portion 112 opposite the first end 110. An accelerator foot pad 114 is disposed at the second end portion 112 and is configured to receive manual inputs from a driver of the vehicle 10 to actuate the propulsion system 12. That is, the accelerator pedal 102 is movable or pivotable relative to the mounting plate 106 and the vehicle 10 between a first position or default position or idle position, where the foot pad 114 is not receiving a manual input from the driver and the propulsion system 12 is not actuated, and a second position or actuated position or depressed position, where manual inputs from a foot of the driver move the accelerator pedal 102 from the idle position to actuate the propulsion system 12 (e.g., FIG. 3C). When moved between the idle position and the actuated position, the accelerator pedal 102 moves or pivots about a rotation axis A 102 that extends through the first end portion 110 of the lever 108. Further, when released from the actuated position (or an intermediate position between the idle position and the actuated position), the accelerator pedal 102 may be biased toward and return to the idle position.

Similarly, the brake pedal 104 includes an arm or lever 116 having a first end portion 118 pivotally mounted at the mounting plate 106 and a second end portion 120 opposite the first end portion 118. A brake foot pad 122 is disposed at the second end portion 120 and is configured to receive manual inputs from a driver of the vehicle 10 to actuate the braking system 14. The brake pedal 104 is movable or pivotable relative to the mounting plate 106 and the vehicle 10 between a first position or default position or idle position, where the foot pad 122 is not receiving a manual input from the driver and the braking system 14 is not actuated, and a second position or actuated position or depressed position, where manual inputs from a foot of the driver move the brake pedal 104 from the idle position to actuate the braking system 14. When moved between the idle position and the actuated position, the brake pedal 104 moves or pivots about a rotation axis A₁₀₄ that extends through the first end portion 118 of the lever 116. As shown in FIG. 2A, the rotation axis A₁₀₂ of the accelerator pedal 102 may be offset from and parallel to the rotation axis A₁₀₄ of the brake pedal 104. When released from the actuated position (or an intermediate position between the idle position and the actuated position), the brake pedal 104 may be biased toward and return to the idle position.

As discussed further below, the pedal system 100 is configured to prevent or preclude simultaneous actuation of the propulsion system 12 and the braking system 14 by preventing or precluding simultaneous operation of the accelerator pedal 102 and the brake pedal 104. That is, the accelerator pedal 102 and the brake pedal 104 may not both move from their respective idle positions toward their respective actuated positions at the same time. Only one of the accelerator pedal 102 and the brake pedal 104 may be moved toward its actuated position at a respective time.

A stopper or mechanical engaging element 124 is disposed at or near the accelerator pedal 102 and pivotable relative to the accelerator pedal 102 and the brake pedal 104 about the rotation axis A₁₀₂ of the accelerator pedal 102 responsive to movement of the accelerator pedal 102 and the brake pedal 104. For example, responsive to the brake pedal 104 moving from its idle position toward its actuated position, the stopper 124 pivots toward engagement with the accelerator pedal 102 and engages the accelerator pedal 102 to preclude movement of the accelerator pedal 102 from its idle position toward its actuated position. Responsive to the accelerator pedal 102 moving from its idle position toward its actuated position, the stopper 124 engages the accelerator pedal 102 and pivots according to movement of the accelerator pedal 102 to preclude movement of the brake pedal 104 from its idle position toward its actuated position. A gear train or linkage system 200 operably connects the accelerator pedal 102, the brake pedal 104, and the stopper 124. The stopper 124 may include an elongated tab or arm that engages at least a portion of the lever 108 of the acceleration pedal 102 to transfer forces between the acceleration pedal 102 and the linkage system 200.

The linkage system 200 includes a first gear 202 that is operably coupled with the brake pedal 104. That is, the first gear 202 rotates according to movement of the brake pedal 104 between its idle position and its actuated position, and similarly the brake pedal 104 may move (and be precluded or prevented from moving) according to movement of the first gear 202. In the illustrated example, the first gear 202 rotates about the rotation axis A₁₀₄ of the brake pedal 104 and is disposed at and/or pivotally connected to the first end 118 of the lever 116.

A second gear 204 rotates relative to the accelerator pedal 102 and rotation of the second gear 204 causes movement of the stopper 124. Likewise, movement of the stopper 124, such as when engaged by the accelerator pedal 102, causes rotation of the second gear 204. In other words, the second gear 204 may be rotatable relative to accelerator pedal 102 and the second gear 204 may be rotatably coupled to the stopper 124. For example, the stopper 124 may be integrally formed with or fixed to the second gear 204. In the illustrated example, the second gear 204 rotates about the rotation axis A₁₀₂ of the accelerator pedal 102 and is disposed at or near the first end 110 of the lever 108. Optionally, the second gear 204 may rotate about another rotation axis offset from the rotation axis A₁₀₂ of the accelerator pedal 102 as long as the second gear 204 is able to rotate relative to the accelerator pedal 102 and the stopper 124 is able to engage the accelerator pedal 102 for transferring forces between the accelerator pedal 102 and the linkage system 200.

Movement of the first gear 202 (and thus movement of the brake pedal 104) and movement of the second gear 204 and stopper 124 (and thus movement of the accelerator pedal 102 through engagement with the stopper 124) is coupled via the gear train or linkage system 200 such that the first gear 202 and the second gear 204 rotate in opposite directions to one another. As shown in FIGS. 2A-2D and 3A-3C, a first linkage system 200, 200a includes a third gear 206 disposed between the first gear 202 and the second gear 204. The third gear 206 is configured to rotate according to rotation of the first gear 202 and in opposing directions from the first gear 202. Although shown as directly interfacing or engaging the first gear 202, it should be understood that in other examples, the third gear 206 may be motivated according to rotation of the first gear 202 in any suitable indirect manner. Moreover, the linkage system 200a is configured to transfer or translate rotation between the third gear 206 and the second gear 204 in the same rotational direction. For example, a linkage 208, like a chain or belt or wire cable or further configuration of gears, may connect the third gear 206 and the second gear 204.

Put another way, the linkage system 200a reverses the rotation of the first gear 202 by including the third gear 206 connected to and rotating with the first gear 202. The linkage 208 is connected to the third gear 206 and rotates in the opposite direction to the first gear 202, functioning to rotate the stopper 124. The stopper 124 and second gear 204 are connected to the linkage 208 to rotate relative to the accelerator pedal 102.

Thus, with the accelerator pedal 102 in its idle position and the brake pedal 104 in its idle position (FIG. 3A), movement of the brake pedal 104 toward its actuated position causes the first gear 202 to pivot or rotate in a first direction 210, such as clockwise about the rotation axis A₁₀₄ of the brake pedal 104 in FIG. 3B. Rotation of the first gear 202 in the first direction 210 causes the third gear 206 to pivot or rotate in a second direction 212 opposite the first direction 210, such as counterclockwise in FIG. 3B. Movement of the third gear 206 may be about a rotation axis A₂₀₆ parallel to and offset from the rotation axis A₁₀₂ of the accelerator pedal 102 and the rotation axis A₁₀₄ of the brake pedal 104. Accordingly, movement of the first gear 202 in the first direction 210 and movement of the third gear 206 in the second direction 212 causes movement of the second gear 204 in the second direction 212 toward engagement with the accelerator pedal 102 (FIG. 3B).

With the stopper 124 engaging the accelerator pedal 102, such as engaging the lever 108 of the accelerator pedal 102 at or near the first end portion 110, the manual force applied to the brake pedal 104 is transferred through the stopper 124 to preclude movement of the accelerator pedal 102. In other words, by pressing the brake pedal 104, the driver engages the stopper 124 with the accelerator pedal 102 and is thus unable to also press the accelerator pedal 102. Releasing the brake pedal 104 causes the brake pedal 104 to move back toward its idle position and thus causes the stopper 124 to move away from the accelerator pedal 102 such that the driver may engage and press the accelerator pedal 102.

In other words, the first gear 202 is integrated on the rotational pivot axis A₁₀₄ of the brake pedal 104. When the brake pedal 104 is pressed, the third gear 206 engaged to the first gear 202 also rotates. This rotational force of the third gear 206 is transmitted to the second gear 204 integrated with the stopper 124 using the linkage 208. The stopper 124 rotates in the opposite direction of the pressing direction of the accelerator pedal 102 and comes into contact with the back of the accelerator pedal 102. This contact is maintained while the brake pedal 104 is pressed, preventing the accelerator pedal 102 from being pressed simultaneously.

With the accelerator pedal 102 in its idle position and the brake pedal 104 in its idle position (FIG. 3A), movement of the accelerator pedal 102 toward its actuated position causes the accelerator pedal 102 to engage the stopper 124 (FIG. 3C). As the accelerator pedal 102 engages the stopper 124 and moves further toward its actuated position, the stopper 124 and the second gear 204 may rotate in the first direction 210. This causes the third gear 206 to rotate in the first direction 210 and thus causes the first gear 202 to rotate in the second direction 212. Movement of the first gear 202 in the second direction 212 may urge the brake pedal 104 away from its actuated position and further toward its idle position, thus precluding or preventing the brake pedal 104 from being moved away from its idle position. That is, by pressing the accelerator pedal 102, the driver engages the accelerator pedal 102 with the stopper 124, which transfers torque to the brake pedal 104 and the driver is unable to also press the brake pedal 104. Releasing the accelerator pedal 102 causes the accelerator pedal 102 to move back toward its idle position away from engagement with the stopper 124 such that the driver may engage and press the brake pedal 104.

That is, when the accelerator pedal 102 is pressed, the accelerator pedal 102 rotates and comes into contact with the stopper 124 in its initial position. This contact is maintained while the accelerator pedal 102 is pressed, which restricts the rotation of the first gear 202 on the rotation axis A₁₀₄ of the brake pedal 104. This ensures that the brake pedal 104 cannot be pressed while the accelerator pedal 102 is being pressed.

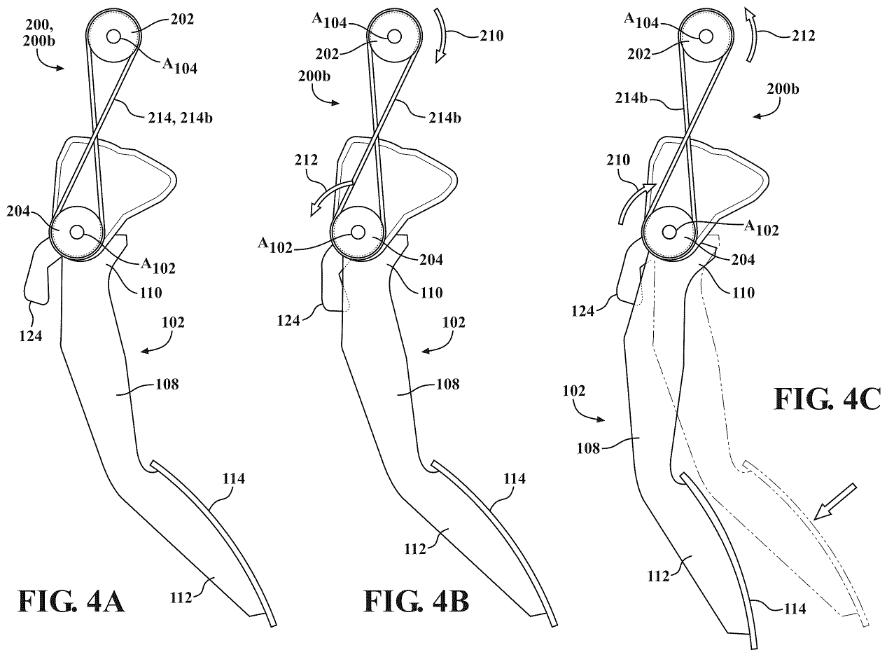

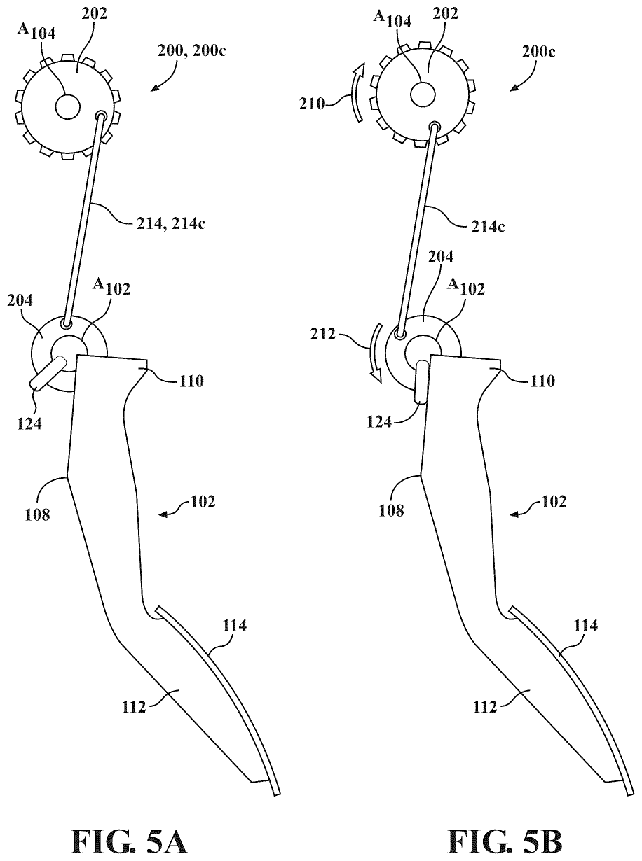

In some examples, the first gear 202 and the second gear 204 may be coupled by a linkage 214 that extends between the first gear 202 and the second gear 204 to cause the first gear 202 and the second gear 204 to rotate in opposite directions from one another during operation of the pedal system 100. In the illustrated example of FIGS. 4A-4C, a second linkage system 200, 200b includes a crossed linkage 214, 214b, such as a chain or belt or cable, that wraps around the first gear 202 and the second gear 204 and crosses over itself to cause the first gear 202 and the second gear 204 to rotate in opposite directions. In the illustrated example of FIGS. 5A and 5B, a third linkage system 200, 200c includes a rigid linkage 214, 214c, such as a rigid wire or rod or lever, that extends between the first gear 202 and the second gear 204 to cause the first gear 202 and the second gear 204 to rotate in opposite directions. For example, the rigid linkage 214c may attach to the respective disks or bodies of the first spur gear 202 and the second spur gear 204. The crossed linkage 214b of the second linkage system 200b and the rigid linkage 214c of the third linkage system 200c may enable similar operation of the pedal system 100, as discussed further below.

Referring to FIGS. 4A-4C and 5A and 5B, with the accelerator pedal 102 and the brake pedal 104 in the respective idle positions (FIGS. 4A and 5A), and responsive to movement of the brake pedal 104 toward its actuated position, the first gear 202 pivots or rotates in the first direction 210 (clockwise in FIGS. 4B and 5B). The crossed linkage 214b and the rigid linkage 214c are each configured to impose opposite movements between the first gear 202 and the second gear 204. Thus, movement of the first gear 202 in the first direction 210 imparts movement of the second gear 204 in the opposite second direction (counterclockwise in FIGS. 4B and 5B). This causes the stopper 124 rotatably coupled to the second gear 204 to move toward engagement with the accelerator pedal 102 (FIGS. 4B and 5B). Engagement of the stopper 124 with the accelerator pedal 102 transfers the manual forces applied to the brake pedal 104 through the linkage system 200 to the accelerator pedal 102 to preclude or prevent movement of the accelerator pedal 102 toward its actuated position. Release of the brake pedal 104 causes the brake pedal 104 to move back toward its idle position, moving the stopper 124 away from the accelerator pedal 102 and allowing the driver to actuate the accelerator pedal 102.

With the accelerator pedal 102 and the brake pedal 104 in their respective idle positions (FIGS. 4A and 5A), movement of the accelerator pedal 102 toward its actuated position causes the accelerator pedal 102 to engage the stopper 124 (FIG. 4C). This transfers manual forces applied to the accelerator pedal 102 through the stopper 124 and the linkage system 200 to the brake pedal 104 to preclude or prevent movement of the brake pedal 104 from its idle position toward its actuated position. For example, engagement of the accelerator pedal 102 with the stopper 124 may cause the stopper 124 and the second gear 204 to rotate in the first direction 210 (FIG. 4C). Movement of the second gear 204 in the first direction 210 imparts movement of the first gear 202 in the opposite second direction 212 via the linkage 214. This may bias or urge or transfer torque to the brake pedal 104 to move or urge the brake pedal 104 further from its idle position away from its actuated position, thus precluding or preventing the driver from actuating the brake pedal 104 with the accelerator pedal 102 actuated.

Referring to FIG. 2D, the dimensions and materials of the pedal system 100 may be configured to reliably and repeatedly withstand manual forces applied by the driver. Dimensions and materials discussed below may be for exemplary purposes only, as other suitable dimensions and materials may be employed. In one example, a first distance or radius R₁₀₂ between the rotation axis A₁₀₂ of the accelerator pedal 102 and the second end portion 112 of the accelerator pedal 102 may be about 199.98 millimeters. A second distance or radius R₁₀₄ between the rotation axis A₁₀₄ of the brake pedal 104 and the second end portion 120 of the brake pedal 104 may be about 280.90 millimeters. A first offset or linear distance L₁₂₄ between the rotation axis A₁₀₂ of the accelerator pedal 102 and the engagement point of the stopper 124 with the accelerator pedal 102 may be about 39.22 millimeters. A second offset or linear distance L₂₀₆ between the rotation axis A₁₀₄ of the brake pedal 104 and second gear 204 and the third gear 206 may be about 34.17 millimeters.

In the illustrated example, the brake pedal 104 generally has a greater radius R₁₀₄ than the accelerator pedal 102 and thus the first gear 202 may experience greater forces when the brake pedal 104 is pressed than the second gear 204 experiences when the accelerator pedal 102 is pressed. Accordingly, materials and dimensions for the linkage system 200 may be configured to withstand at least forces experienced when the brake pedal 104 is pressed by the driver. For example, according to vehicular engineering standards, a driver may apply a manual force F of up to 668 Newtons (about 150 pounds) or more when the foot pad 114, 122 of the pedal 102, 104 is pressed. At a pedal to gear ratio between the brake pedal foot pad 122 and the first gear 202 of 10 to 1, this results in force of up to 6,680 Newtons (about 1,500 pounds) at the first gear 202. To accommodate these forces, the first gear 202 may have a pitch diameter of about 56 millimeters, a pitch radius of about 28 millimeters, and be formed from a steel alloy such as AISI 4140 having a tensile strength of about 655 megapascals and an allowable stress of about 393 megapascals. This may result in the first gear 202 (and optionally other gears of the linkage system 200) having a thickness of about 17 millimeters or more to withstand the manual force F applied by the driver and transfer the manual force F between the accelerator pedal 102 and the brake pedal 104.

Thus, the brake pedal 104 and the accelerator pedal 102 are interconnected by a mechanical structure such that when either the brake pedal 104 or the accelerator pedal 102 is pressed by the driver, the other pedal cannot be pressed by the driver. In the illustrated example, the pedal system 100 provides a linkage system 200 that prevents or precludes simultaneous operation of the accelerator pedal 102 and the brake pedal 104 by the driver, thereby preventing road hazards, strain on the propulsion system 12 and braking system 14 of the vehicle 10, and preventing or precluding the vehicle 10 from accelerating due to incorrect operation.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicular pedal system comprising:
an accelerator pedal configured to pivotably mount at a vehicle equipped with the vehicular pedal system, the accelerator pedal configured to pivot between a first position, where a propulsion system of the vehicle is not actuated, and a second position, where the propulsion system of the vehicle is actuated;
a brake pedal configured to pivotably mount at the vehicle, the brake pedal configured to pivot between a first position, where a braking system of the vehicle is not actuated, and a second position, where the braking system of the vehicle is actuated;
a stopper pivotable relative to the accelerator pedal and the brake pedal, the stopper configured to:
responsive to the brake pedal moving from its first position toward its second position, pivot toward engagement with the accelerator pedal to preclude movement of the accelerator pedal from its first position toward its second position; and
responsive to the accelerator pedal moving from its first position toward its second position, engage the accelerator pedal and pivot according to movement of the accelerator pedal to preclude movement of the brake pedal from its first position toward its second position.

2. The vehicular pedal system of claim 1, wherein the accelerator pedal and the stopper are configured to pivot about a first pivot axis and the brake pedal is configured to pivot about a second pivot axis different than the first pivot axis.

3. The vehicular pedal system of claim 1, further comprising a gear train that is operably connected to the accelerator pedal, the brake pedal, and the stopper.

4. The vehicular pedal system of claim 3, wherein the gear train includes a first gear pivotable according to movement of the brake pedal and a second gear pivotable relative to the accelerator pedal, the stopper pivotable according to movement of the second gear.

5. The vehicular pedal system of claim 4, wherein, responsive to the brake pedal moving from its first position toward its second position, the first gear pivots in a first direction and causes the second gear to pivot in an opposite second direction to move the stopper toward engagement with the accelerator pedal.

6. The vehicular pedal system of claim 5, wherein, responsive to the accelerator pedal moving from its first position toward its second position, the accelerator pedal engages the stopper and causes the second gear to move in the first direction to move the first gear in the first direction and preclude movement of the brake pedal.

7. The vehicular pedal system of claim 4, wherein the gear train includes a third gear disposed between the first gear and the second gear.

8. The vehicular pedal system of claim 7, wherein a linkage extends between the third gear and the second gear to pivotably connect the second gear and the third gear.

9. The vehicular pedal system of claim 4, wherein a linkage extends between the first gear and the second gear to pivotably connect the first gear and the second gear.

10. The vehicular pedal system of claim 1, further comprising a mounting plate configured to mount at an interior cabin of the vehicle, the accelerator pedal including a first lever having a first end pivotably mounted at the mounting plate and an opposite second end including a first foot pad configured to receive an accelerator pedal actuation force from a driver of the vehicle that moves the accelerator pedal from its first position toward its second position, and the brake pedal including a second lever having a first end pivotably mounted at the mounting plate and an opposite second end including a second foot pad configured to receive a brake pedal actuation force from the driver of the vehicle that moves the brake pedal from its first position toward its second position.

11. A vehicle comprising:
a pedal system including:
an accelerator pedal pivotably mounted at the vehicle, the accelerator pedal configured to pivot between a first position, where a propulsion system of the vehicle is not actuated, and a second position, where the propulsion system of the vehicle is actuated;
a brake pedal pivotably mounted at the vehicle, the brake pedal configured to pivot between a first position, where a braking system of the vehicle is not actuated, and a second position, where the braking system of the vehicle is actuated;
a stopper pivotable relative to the accelerator pedal and the brake pedal, the stopper configured to:
responsive to the brake pedal moving from its first position toward its second position, pivot toward engagement with the accelerator pedal to preclude movement of the accelerator pedal from its first position toward its second position; and
responsive to the accelerator pedal moving from its first position toward its second position, engage the accelerator pedal and pivot according to movement of the accelerator pedal to preclude movement of the brake pedal from its first position toward its second position.

12. The vehicle of claim 11, wherein the accelerator pedal and the stopper are configured to pivot about a first pivot axis and the brake pedal is configured to pivot about a second pivot axis different than the first pivot axis.

13. The vehicle of claim 11, wherein the pedal system further includes a gear train that is operably connected to the accelerator pedal, the brake pedal, and the stopper.

14. The vehicle of claim 13, wherein the gear train includes a first gear pivotable according to movement of the brake pedal and a second gear pivotable relative to the accelerator pedal, the stopper pivotable according to movement of the second gear.

15. The vehicle of claim 14, wherein, responsive to the brake pedal moving from its first position toward its second position, the first gear pivots in a first direction and causes the second gear to pivot in an opposite second direction to move the stopper toward engagement with the accelerator pedal.

16. The vehicle of claim 15, wherein, responsive to the accelerator pedal moving from its first position toward its second position, the accelerator pedal engages the stopper and causes the second gear to move in the first direction to move the first gear in the first direction and preclude movement of the brake pedal.

17. The vehicle of claim 14, wherein the gear train includes a third gear disposed between the first gear and the second gear.

18. The vehicle of claim 17, wherein a linkage extends between the third gear and the second gear to pivotably connect the second gear and the third gear.

19. The vehicle of claim 14, wherein a linkage extends between the first gear and the second gear to pivotably connect the first gear and the second gear.

20. The vehicle of claim 11, wherein the pedal system further includes a mounting plate configured to mount at an interior cabin of the vehicle, the accelerator pedal including a first lever having a first end pivotably mounted at the mounting plate and an opposite second end including a first foot pad configured to receive an accelerator pedal actuation force from a driver of the vehicle that moves the accelerator pedal from its first position toward its second position, and the brake pedal including a second lever having a first end pivotably mounted at the mounting plate and an opposite second end including a second foot pad configured to receive a brake pedal actuation force from the driver of the vehicle that moves the brake pedal from its first position toward its second position.
